(19) United States
(12) Patent Application Publication
(10) Pub. No.: US 2008/0055460 A1
(43) Pub. Date: Mar. 6, 2008

(54) AUTO FOCUS METHOD FOR OBTAINING IMAGE HAVING TWO SUBJECTS

(75) Inventor: Wei Hsu, Taipei (TW)

Correspondence Address: MADSON & AUSTIN, 15 WEST SOUTH TEMPLE, SUITE 900, SALT LAKE CITY, UT, 84101, US

(73) Assignee: Primax Electronics Ltd., Taipei (TW)

(21) Appl. No.: 11/834,859

(22) Filed: Aug. 7, 2007

(30) Foreign Application Priority Data
Sep. 1, 2006 (TW) 095132358

(51) Int. Cl. G03B 13/00

(52) U.S. Cl. 348/345

(57) ABSTRACT

The present invention relates to an auto focus method for obtaining a sharp image of two subjects. The auto focus method includes the following steps. Firstly, a pre-taken image is obtained by focusing on a first subject with an image capture device. Then, the pre-taken image is divided into a first area and a second area. According to image analysis, a first focusing lens step number for the first area and a second focusing lens step number for the second area are obtained. Then, a first image is obtained by focusing on the first area of the pre-taken image. By comparing the first focusing lens step number with the second focusing lens step number, it is discriminated whether a second image is captured or not.

### FIELD OF THE INVENTION

The present invention relates to an auto focus method, and more particularly to an auto focus method for obtaining an image having two subjects.

### BACKGROUND OF THE INVENTION

Currently, digital image capture devices such as digital cameras and camera phones are widely used to take photographs. With increasing development of technologies, digital image capture devices become essential electronic products because they are excellent in their performance and are small and exquisite in their appearance. For leisure, digital cameras are widely used when traveling.

As known, the definition of the subject taken by the image capture device is largely effected by the focusing operation of the image capture device. In order to achieve high image quality of the subject, the focal length should be properly adjusted to focus on the subject. In other words, the quality of the digital camera or the camera phone is highly dependent on the auto focus method applied thereto. The focusing accuracy is affected by many factors. For example, insufficient illumination, low contrast, two-subject effect and/or glass's reflection may deteriorate the focusing accuracy of the image capture device.

The two-subject effect usually occurs when two subjects are located within the shooting range. In a case that these two subjects are very close to each other or the subject with a higher sharpness value is located behind the subject with a lower sharpness value, the image capture device may fail to distinguish which subject needs to be focused on. As a consequence, the two-subject effect usually deteriorates the focusing accuracy of the image capture device.

The glass's reflection usually occurs when a reflective article (e.g. glass) is located within the shooting range. Even if a subject is located within the shooting range, the mirror image may act like a second subject. Under this circumstance, the two-subject effect as described above is readily resulted.

In the event of poor focusing or defocus as described above, the photographer may often retake the image by the image capture device. Since the scene and the hardware and software of the image capture device are kept unchanged, the possibility of causing the two-subject effect is very high. As known, the manual focus method possibly overcomes such a problem. However, the complicated operating procedures of the manual focus method become hindrance from using the image capture apparatus because most users are not well-educated in the manual focus method.

Therefore, there is a need of providing an improved focus method for overcoming the above-mentioned drawbacks.

### SUMMARY OF THE INVENTION

It is an object of the present invention to provide an auto focus method for obtaining an image having two subjects.

In accordance with an aspect of the present invention, there is provided an auto focus method for obtaining a sharp image of two subjects. These two subjects include a first subject and a second subject and are located within a shooting range. The auto focus method includes the following steps. Firstly, a pre-taken image is obtained by focusing on the first subject with an image capture device. Then, the pre-taken image is divided into a first area and a second area, wherein the first subject is included in the first area. According to image analysis, a first focusing lens step number for the first area and a second focusing lens step number for the second area are obtained. Then, a first image is obtained by focusing on the first area of the pre-taken image. By comparing the first focusing lens step number with the second focusing lens step number, it is discriminated whether a second image is captured or not. When the first focusing lens step number and the second focusing lens step number lie within two different depth-of-field ranges, the second image is obtained by focusing on the second area of the pre-taken image. Whereas, the second image is not captured when the first focusing lens step number and the second focusing lens step number lie within the same depth-of-field range.

In an embodiment, the first area and the second area are determined by steps of dividing the pre-taken image into multiple blocks having respective focus values, and grouping the multiple blocks into either the first area or the second area according to the focus values.

In an embodiment, the blocks of the first area have relatively higher focus values than the blocks of the second area.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic image analysis diagram illustrating the image of two subjects within a shooting range; and

FIGS. 2(A), 2(B), 2(C) and 2(D) are focusing curve plots according to a preferred embodiment of the present invention.

### DETAILED DESCRIPTION OF THE PREFERRED EMBODIMENT

For avoiding poor focusing or defocus resulting from the two-subject effect, the present invention provides an auto focus method for obtaining an image having two subjects. The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

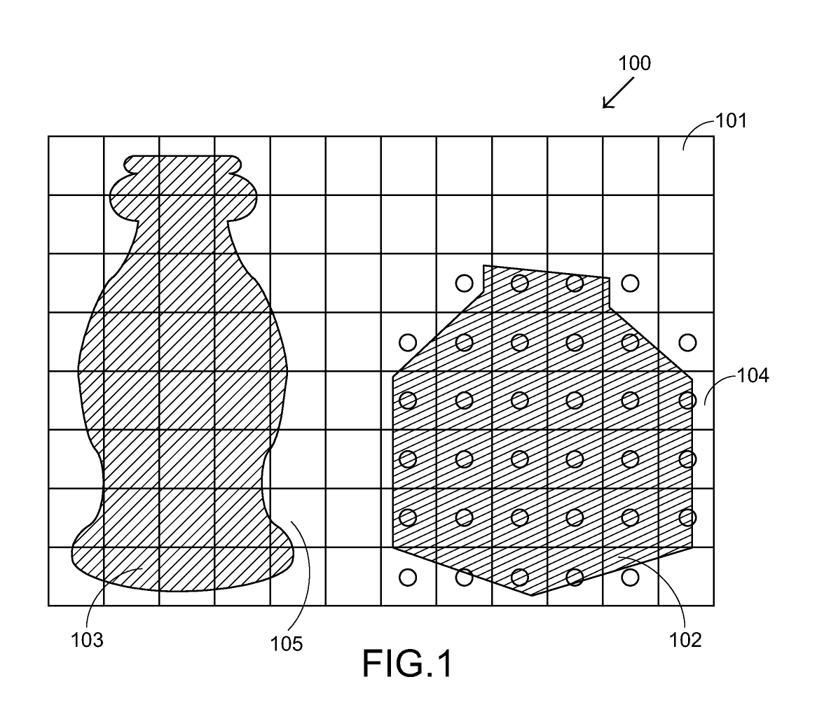

Hereinafter, a first subject and a second subject to be taken by an image capture device will be illustrated as follows. Please refer to FIG. 1, which is a schematic image analysis diagram illustrating the image having two subjects within a shooting range. As shown in FIG. 1, the images of a first subject 102 and a second subject 103 are intended to be captured. First of all, by focusing on the first subject 102, the image capture device captures a pre-taken image 100. Then, the pre-taken image 100 is divided into multiple blocks 101, for example 12×8 blocks 101. All block 101 have respective focus values. Then, the focus values of these blocks 101 are arranged in descending order. In an embodiment, 40% of the total blocks 101 having the relatively higher focus values are grouped into a first area 104. As shown in the figure, a symbol “O” is marked on the block 101 which are contained in the first area 104. Generally, the image of the first subject 102 is included in the first area 104. The pre-taken image 100 excluding the first area 104 is grouped into a second area 105. As shown in the figure, the blocks which have no symbol “O” marked thereon are grouped into the second area 105. Generally, the image of the second subject 103 is included in the second area 105.

Next, by using the conventional image analysis method, a first focusing lens step number for the first area 104 and a second focusing lens step number for the second area 105 are obtained. If the second focusing lens search step number fails to be analyzed sometimes, the second focusing lens search step number will be obtained by focusing the second area 105. After the image analysis as described above, the image capture device is focused on the first area 104 to capture a first image. Next, the first focusing lens step number is compared with the second focusing lens step number. If the first focusing lens step number and the second focusing lens step number lie within the same depth-of-field range, it means that the focus values (or sharpness values) of the image obtained by focusing on the first area 104 are close to the focus values of the image obtained by focusing on the second area 105. Meanwhile, the first image is recognized as a representative image and no additional image needs to be captured. Otherwise, if the first focusing lens step number and the second focusing lens step number lie within two different depth-of-field ranges, it means that the focus values of the image obtained by focusing on the first area 104 are far from the focus values of the image obtained by focusing on the second area 105. Under this circumstance, the image capture device needs to be focused on the second area 105 to capture a second image. By visual recognition, the user may decide whether the first image or the second image is retained, thereby saving time.

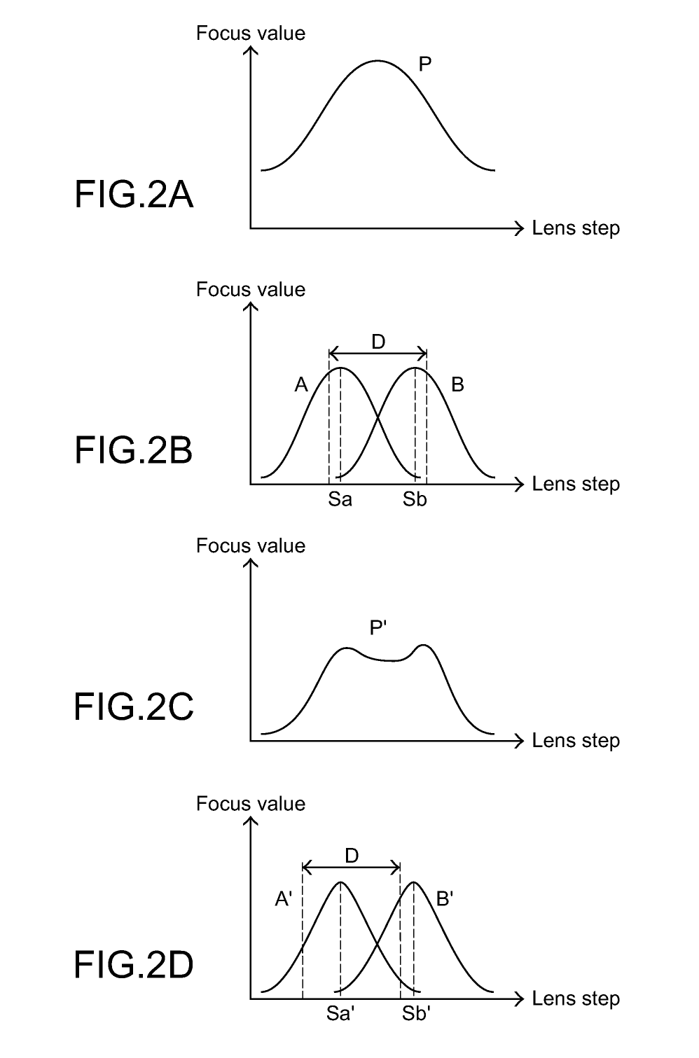

The operation principles of the auto focus method according to the present invention will be illustrated with reference to FIGS. 2(A), 2(B), 2(C) and 2(D). In these drawings, the horizontal axle indicates the lens steps, and the vertical axle indicates the corresponding focus values. In FIGS. 2(A) and 2(B), it is not necessary to capture the second image. Whereas, in FIGS. 2(C) and 2(D), capturing the second image is required.

FIG. 2(A) is a focusing curve plot of the pre-taken image 100 shown in FIG. 1. The focusing curve P of the pre-taken image illustrates the relationship between focus values and lens steps for the whole pre-taken image.

The focusing curve A of FIG. 2(B) illustrates the relationship between focus values and lens steps for the image obtained by focusing on the first area. The focusing curve B of FIG. 2(B) illustrates the relationship between focus values and lens steps for the image obtained by focusing on the second area. The lens step number Sa corresponding to the maximum focus value in the curve A is recorded as the first focusing lens step number. Whereas, the lens step number Sb corresponding to the maximum focus value in the curve B is recorded as the second focusing lens step number. As known, due to the depth of field for the optical element, the focus values within the depth-of-field range (i.e. zone D) are acceptable for obtaining sharp images. As shown in FIG. 2(B), since the first focusing lens step number Sa and the second focusing lens step number Sb both lie within the same depth-of-field range, the whole pre-taken image may be considered as a sharp image. In other words, the first image obtained by focusing on the first area and the second image obtained by focusing on the second area are both sharp images. The first focusing lens step number Sa and the second focusing lens step number Sb both lying within the same depth-of-field range indicates that the first image obtained by focusing on the first area and the second image obtained by focusing on the second area are very close in their sharpness degrees. For reducing memory occupancy, the procedure of capturing the second image by focusing on the second area may be dispensed with. Under this circumstance, the first image is acceptable.

The situation where it is necessary to capture the second image will be illustrated as follows. FIG. 2(C) is a focusing curve plot of another pre-taken image. The focusing curve P′ of the pre-taken image illustrates the relationship between focus values and lens steps for the whole pre-taken image. When compared with the focusing curve P shown in FIG. 2(A), the focusing curve P′ of FIG. 2(C) is wider.

The focusing curve A′ of FIG. 2(D) illustrates the relationship between focus values and lens steps for the image obtained by focusing on the first area. The focusing curve B′ of FIG. 2(D) illustrates the relationship between focus values and lens steps for the image obtained by focusing on the second area. The lens step number Sa′ corresponding to the maximum focus value in the curve A′ is recorded as the first focusing lens step number. Whereas, the lens step number Sb′ corresponding to the maximum focus value in the curve B′ is recorded as the second focusing lens step number. As shown in FIG. 2(D), the first focusing lens step number Sa′ lies within the depth-of-field range D but second focusing lens step number Sb′ is beyond the depth-of-field range D. The curves A′ and B′ indicates that the first area of the pre-take image is sharp but the second area of the pre-take image is blurred. Since the first area of the pre-take image is not suffered from poor focusing or defocus, only the second area of the pre-take image needs to be automatically focused in order to obtain a sharp image of the second subject.

The present invention is illustrated by referring to an auto focus method for avoiding the two-subject effect. Nevertheless, the auto focus method of the present invention can be applied to minimize the influence of glass's reflection. Even if a subject is located within the shooting range, the mirror image (i.e. the reflected subject) may act as a second subject. By respectively focusing the first area and the second area, two sharp images are obtained but the sharp image of the reflected subject needs not be retained.

In accordance with the auto focus method of the present invention, the images of two subjects are recognized as two objects to be captured by the image capture device. In a case that a single subject is in a low-contrast background, the single subject and the background are recognized as the first subject and the second subject, respectively. By respectively focusing the first area and the second area, two sharp images are obtained and the user may decide which image should be retained. When the first focusing lens step number and the second focusing lens step number lie within two different depth-of-field ranges, the first image is acceptable as the representative image. Moreover, the auto focus method of the present invention may be implemented by programs. After an activating button is clicked to take a photograph, the other tasks associated with the auto focus method are done by the programs. As a consequence, the auto focus method of the present invention is more user-friendly and convenient and may reduce memory occupancy. More importantly, the auto focus method of the present invention is applicable to general digital image capture devices. In compared with the advanced image capture devices having the manual focus functions, the digital image capture devices adopting the auto focus method of the present invention are more cost-effective and more popular.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An auto focus method for obtaining a sharp image of two subjects, said two subjects including a first subject and a second subject and being located within a shooting range, said auto focus method comprising steps of:
focusing on said first subject by an image capture device to obtain a pre-taken image;
dividing said pre-taken image into a first area and a second area, said first subject being included in said first area;
obtaining a first focusing lens step number for said first area and a second focusing lens step number for said second area according to image analysis;
focusing on said first area of said pre-taken image to obtain a first image;
discriminating whether a second image is captured by comparing said first focusing lens step number with said second focusing lens step number; and
focusing on said second area of said pre-taken image to obtain said second image when said first focusing lens step number and said second focusing lens step number lie within two different depth-of-field ranges, wherein said second image is not captured when said first focusing lens step number and said second focusing lens step number lie within the same depth-of-field range.

2. The auto focus method according to claim 1 wherein said first area and said second area are determined by steps of:
dividing said pre-taken image into multiple blocks, which have respective focus values; and
grouping said multiple blocks into either said first area or said second area according to said focus values.

3. The auto focus method according to claim 2 wherein the blocks of said first area have relatively higher focus values than the blocks of said second area.
